(19) United States
(12) Patent Application Publication
(10) Pub. No.: US 2025/0132693 A1
(43) Pub. Date: Apr. 24, 2025

(54) METHOD, COMPUTER PROGRAM, AND CONTROLLER FOR CONTROLLING AN ELECTRICAL CONVERTER, ELECTRICAL CONVERTER, AND COMPUTER-READABLE MEDIUM

(71) Applicant: ABB SCHWEIZ AG, Baden (CH)

(72) Inventors: Georgios Darivianakis, Zurich (CH); Tobias Geyer, Ennetbaden (CH); Peter Muszynski, Espoo (FI); Ioannis Tsoumas, Zurich (CH)

(21) Appl. No.: 18/836,404

(22) PCT Filed: Jan. 10, 2023
(86) PCT No.: PCT/EP2023/050425

§ 371 Date: Aug. 7, 2024

(30) Foreign Application Priority Data
Feb. 9, 2022 (EP) 22155947.9

(51) Int. Cl. H02M 7/5395

(52) U.S. Cl. CPC H02M 7/5395

(57) ABSTRACT

A method for controlling an electrical converter for driving an electrical machine comprises the steps of: estimating a stator flux vector depending on at least one measurement in the electrical converter; determining an optimized pulse pattern for the electrical converter depending on a reference angular stator frequency; determining a reference stator angle of the stator flux vector depending on the reference angular stator frequency; determining a reference stator flux vector depending on the optimized pulse pattern and the reference stator angle; determining a difference between the reference stator flux vector and the estimated stator flux vector; modifying switching instants of the optimized pulse pattern, such that the difference is minimized; and applying at least a part of the modified optimized pulse pattern to the electrical converter.

### CROSS-REFERENCE TO RELATED APPLICATIONS

This application claims priority to International Patent Application No. PCT/EP2023/050425, filed Jan. 10, 2023 and titled “METHOD, COMPUTER PROGRAM, AND CONTROLLER FOR CONTROLLING AN ELECTRICAL CONVERTER, ELECTRICAL CONVERTER, AND COMPUTER-READABLE MEDIUM”, which claims priority to European Patent Application No. 22155947.9, filed Feb. 9, 2022 and titled “METHOD, COMPUTER PROGRAM, AND CONTROLLER FOR CONTROLLING AN ELECTRICAL CONVERTER, ELECTRICAL CONVERTER, AND COMPUTER-READABLE MEDIUM”, and the entire contents of each are hereby incorporated by reference in their entirety.

### TECHNICAL FIELD

The disclosure relates to the field of high-power electronics. In particular, the disclosure relates to a method, a computer program, and a controller for controlling an electrical converter, and to an electrical converter and a computer-readable medium, on which the computer program may be stored.

### BACKGROUND

Optimized pulse patterns (OPPs) relate to a specific pulse width modulation method. Offline computed and optimized pulse patterns may be used for modulating the semiconductor switches in an electrical converter. Based on the actual speed and flux reference (provided for example by an outer control loop), a controller may determine a best suited offline computed pulse pattern, which then may be applied to the semiconductor switches of the electrical converter. Offline computed optimized pulse patterns may allow the minimization of the overall current distortion for a given switching frequency.

When the electrical converter is used for driving an electrical machine, the harmonic losses in the stator winding of the electrical machine may be proportional to the current distortion, while the switching losses of the power inverter may be related to the switching frequency. In a grid-connected converter setting, stringent standards may be imposed on the voltage and current distortions a converter may inject into the grid. Traditionally, it has only been possible to use optimized pulse patterns in a modulator driven by a very slow control loop. This may lead to very long transients and to harmonic excursions of the currents when changing the operating point.

EP 2 469 692 A1 describes a control method that combines the merits of direct torque control and optimized pulse patterns, by manipulating in real time the switching instants of the pre-computed optimized pulse patterns, so as to achieve fast closed-loop control. This so-called model predictive pulse pattern controller (MP³C) may address in a unified approach the tasks of the inner current control loop and modulator. MP³C may control a flux vector, which, in case of an electrical converter driving an electrical machine, is typically the stator flux linkage vector of the electrical machine. For grid-connected converters, the virtual converter flux may constitute the flux vector.

MP³C achieves short response times during transients, and a good rejection of disturbances. At steady-state operating conditions, due to the usage of optimized pulse patterns, a nearly optimal ratio of harmonic current distortions per switching frequency may be obtained. Compared to state-of-the-art trajectory controllers, MP³C may provide two advantages. First, a complicated observer structure to reconstruct the fundamental quantities may not be required. Instead, a flux space vector, which may be the controlled variable, may be estimated directly by sampling the currents and the DC-link voltage at regular sampling intervals. Second, by formulating an optimal control problem and using a receding horizon policy, the sensitivity to flux observer noise may be greatly reduced.

During transient operation, such as reference step or ramp changes, large disturbances and faults, the controlled variables, such as currents, electromagnetic torque and flux linkage, are typically required to change in a step-like fashion or they may have to follow a steep ramp. Examples may include fast torque steps in high performance drives and power steps in low-voltage ride through operation.

In MP³C, closed-loop control may be achieved by modifying the switching instants of the optimized pulse patterns' switching transitions in real time. More specifically, the switching transitions are modified in time such that the flux error may be removed at a future time instant. Note that in optimized pulse patterns, the switching transitions are not evenly distributed in time. At very low switching frequencies, long time intervals may arise between two switching transitions. When a reference step is applied at the beginning of such a time interval, a significant amount of time may elapse before the controlled variables start to change, resulting in a long initial time delay and also prolonging the settling time.

Once the controlled variable has started to change, the transient response may be sluggish and significantly slower than when using deadbeat control or direct torque control, for example. The sluggish response is typically due to the absence of a suitable voltage vector that moves the controlled flux vector with the maximum speed and in the direction that ensures the fastest possible compensation of the torque or current error. In order to ensure a very fast transient response during a transient, at least one phase may need to be connected to the upper or lower DC-link rail of the converter. In a low-voltage ride through setting, for example, this may imply reversing the voltage in at least one phase from its maximal to its minimal value, or vice versa, during a major part of the transient.

Directly related to the behaviour of sluggish transient responses is the issue of current excursions during transients. Such excursions may occur when the switching transitions, which are to be shifted in time so as to remove the flux error, are spread over a long time interval. This may increase the risk that the flux vector is not moved along the shortest path from its current to its new desired position. Instead, the flux vector may temporarily deviate from this path, exceeding its nominal magnitude. This may be equivalent to a large current, which may result in an over-current trip.

Related issues may also arise at quasi steady-state operating conditions, where small variations in the operating point and/or the inverter voltages occur. Specifically, fluctuations in the DC-link voltage, resistive voltage drops in the machine's stator windings or in the grid impedance and transitions between different pulse patterns may lead to a degradation of the closed-loop performance of MP³C, if they are not properly accounted for.

Particularly in cases, where the optimized pulse patterns' switching transitions exhibit an uneven distribution in time and when a very low switching frequency is used, these flux errors may not be accounted for in a timely fashion due to the absence of suitable switching transitions. As a result, large flux errors may arise that build up and persist over significant periods of time, leading to a poor tracking of the optimized pulse pattern's optimal flux trajectory. This may impact the total harmonic distortion of the current in a detrimental way.

With respect to the above problems, EP 2 891 241 B1 describes a method for using MP³C for drive systems, which has been proven a reliable method to regulate the rotor speed. In particular, EP 2 891 241 B1 describes a manipulation of the switching instants of the offline computed OPP in real time. However, to achieve so, the method and in particular MP³C relies on knowledge of the machine type and its parameters, and an accurate online estimation of the rotor flux. So, in order to be able to use MP³C, the machine type and its parameters had to be known and an accurate online estimation of the rotor flux had to be carried out. Thus, the machine type and its parameters had to be known when the controller for controlling the electrical machine is produced. So, it was not possible to produce and/or program a generally usable controller which may work for different machine types, wherein at least some of these different machine types were not known at the time of the production and/or, respectively programming of the controller. Moreover, some machine parameters may not be known or available at the time of commissioning of the converter drive system, and/or they may be time varying. In addition, accurately estimating the rotor flux online may require large processing resources and/or a relatively long time.

### BRIEF DESCRIPTION

It is an object of the present disclosure to overcome the above-mentioned problems. In particular, it is an object of the present disclosure to provide a method for controlling an electrical converter for driving an electrical machine, wherein the method may be carried out without any knowledge about the machine type of the electrical machine and its parameters, wherein the method is quick to commission, wherein the method only requires few processing resources, and/or wherein the method may be carried out quickly. Further, it is an object of the present disclosure to provide a corresponding computer program, a corresponding controller for controlling an electrical converter, a corresponding an electrical converter, and a corresponding computer-readable medium.

These objects are achieved by the subject-matter of the independent claims. Further exemplary embodiments are evident from the dependent claims and the following description.

An aspect relates to a method for controlling an electrical converter for driving an electrical machine. The electrical converter may be an inverter or an active rectifier. It may be an indirect or a direct converter. In particular, the converter may be a high-power converter adapted for converting current with more than 100 A and/or 1000 V. The electrical machine may be an electric motor or a generator, or it may be operated as an electric motor in a first operation mode and as a generator in a second operation mode.

According to an embodiment, the method comprises the steps of: estimating a stator flux vector depending on at least one measurement in the electrical converter; determining an optimized pulse pattern for the electrical converter depending on a reference angular stator frequency; determining a reference stator angle of the stator flux vector depending on the reference angular stator frequency; determining a reference stator flux vector depending on the optimized pulse pattern and the reference stator angle; determining a difference between the reference stator flux vector and the estimated stator flux vector; modifying switching instants of the optimized pulse pattern, such that the difference is minimized; and applying at least a part of the modified optimized pulse pattern to the electrical converter.

This enables one to drive the electrical machine without knowing the machine type of the electrical machine and its parameters. Further, no online estimation of the rotor flux has to be carried out. Thus, the machine type and its parameters do not have to be known when the controller for carrying out the method is produced. So, the above method enables one to produce and/or program a generally usable controller which may work for different machine types, wherein at least some of these different machine types are not known at the time of the production and/or, respectively programming of the controller. In addition, no large processing resources and/or relatively long processing times are required for accurately estimating the rotor flux online.

The above method provides a Model-Free Scalar Pulse Pattern Control (MF-SPPC) scheme. The MF-SPPC scheme may be a scalar closed-loop control scheme that achieves speed-control of an electrical machine by regulating a magnitude of the stator flux to its reference value, the reference stator flux magnitude, during transient events and in the presence of disturbances in a dc-link voltage of the electrical system comprising the electrical converter and the electrical machine. This task may be achieved for a given and/or predetermined reference angular stator frequency (or speed). By adjusting the reference angular stator frequency, a steady state value of an angular rotor speed may also be adjusted. In case of the electrical machine being an induction machine, the angular rotor speed will only approximate the reference angular stator frequency at steady state due to a slip between the rotor and the stator of the electrical machine. In case of a Permanent Magnet Synchronous Machine (PMSM), the angular rotor speed will eventually converge to the reference angular stator frequency at steady state due to a synchronism in the rotor and stator magnetic fields. Special care may be needed when adjusting the angular stator frequency not to drive the PMSM out of its synchronization. In this context, the MF-SPPC scheme may be seen as a bare bone control scheme based on OPPs which does not rely on any knowledge of the machine type and its parameters to achieve its control objectives.

The stator flux vector may be referred to as stator flux linkage vector.

According to an embodiment, the reference stator angle is determined by integrating the reference angular stator frequency. The reference stator angle may be determined by a proportional-integral (PI) controller which receives the reference angular stator frequency as an input.

According to an embodiment, the optimized pulse pattern is be determined depending on the reference stator flux magnitude. The reference stator flux magnitude may be set to “1” during nominal operation. Values below 1 may be used for induction machines operating at speeds exceeding its field-weakening point, so called field weakening. The fundamental component may determine a modulation index of the optimized pulse pattern.

According to an embodiment, the optimized pulse pattern is determined depending on a modulation index and/or a maximum allowed switching frequency. The modulation index may be determined depending on a reference stator flux magnitude. The maximum allowed switching frequency may be determined in advance, e.g. empirically, e.g. by a manufacturer of the electrical converter and/or the controller.

According to an embodiment, the at least one measurement in the electrical converter comprises measuring a stator voltage of the electrical converter. The stator flux vector may be estimated depending on the stator voltage.

According to an embodiment, the optimized pulse pattern comprises a sequence of switching transitions at switching instants between different switching states of the converter. The optimized pulse pattern may be loaded from a table of optimized pulse patterns stored in the controller performing the above method. The table of optimized pulse patterns may be indexed with respect to the modulation index. Optionally, the table of optimized pulse patterns may be indexed with respect to the maximal switching frequency. For each optimized pulse pattern in the table, switching transitions at switching instants may be stored. Optionally, for each optimized pulse pattern in the table a reference stator flux may be stored.

Another aspect relates to a computer program, which when being executed on a processor, e.g. a processor of the controller, is adapted for executing the steps of the above method.

Another aspect relates to a computer-readable medium in which the computer program is stored. The computer-readable medium may be a floppy disk, a hard disk, an USB (Universal Serial Bus) storage device, a RAM (Random Access Memory), a ROM (Read Only Memory), and an EPROM (Erasable Programmable Read Only Memory). The computer-readable medium may also be a data communication network, e.g. the Internet, which allows downloading a program code.

Another aspect relates to a controller for controlling the electrical converter adapted for executing the steps of the above method. For example, the control method, i.e. the above method, may be implemented on any computational hardware including DSPs, FPGAs, microcontrollers, CPUs, GPUs, multi-core platforms, and combinations thereof. In particular, the controller may comprise a memory in which the above-mentioned computer program is stored and may comprise the processor for executing the computer program.

Another aspect relates to an electrical converter, comprising a plurality of semiconductor switches and the above controller adapted for controlling the semiconductor switches of the electrical converter. The converter may be any multi-level power converter, such as a two-level converter, a three-level converter, a neutral point clamped three-level converter, a flying-capacitor four-level converter, a five-level converter, a cascaded H-bridge five-level converter, a modular multi-level converter, etc.

The electrical converter may be used on the machine side and/or on the grid side. For example, on the machine side case, the controller may control the electrical machine's stator flux vector along a pre-defined and optimal trajectory. A sine filter with inductive and capacitive elements and/or a long cable may be present between the electrical converter and the electrical machine. The controlled variables may comprise the electromagnetic torque and/or the magnitudes of the stator flux vectors. In the grid side case, the electrically converter may be connected via a sine filter and/or a transformer to the grid. The electrical converter's virtual flux vector may be controlled along a given trajectory by manipulating the converter switches. The controlled variables may comprise the real and/or the reactive power and/or the converter currents and/or the virtual converter flux.

It has to be understood that features of the method as described in the above and in the following may be features of the computer program, the computer-readable medium, the controller, and/or the electrical converter as described in the above and in the following.

These and other aspects of the disclosure will be apparent from and elucidated with reference to the embodiments described hereinafter.

### BRIEF DESCRIPTION OF THE DRAWINGS

The subject-matter of the disclosure will be explained in more detail in the following text, with reference to exemplary embodiments which are illustrated in the attached drawings.

FIG. 1 shows a circuit representation of an induction machine model in a rotating dq-reference frame for a d-axis.

FIG. 2 shows a circuit representation of an induction machine model in the rotating dq-reference frame of FIG. 1 for a q-axis.

FIG. 3 illustrates a definition of the rotating dq-reference frame of FIGS. 1 and 2.

FIG. 4 shows a circuit representation of a permanent-magnet synchronous machine in the rotating dq-reference frame of FIG. 3 for a d-axis.

FIG. 5 shows a circuit representation of a permanent-magnet synchronous machine in the rotating dq-reference frame of FIG. 3 for a q-axis.

FIG. 6 shows an example of a switching pattern modification by MP³C.

FIG. 7 schematically shows an electrical system with a converter according to an embodiment.

FIG. 8 shows a flow diagram of an exemplary embodiment of a method for controlling an electrical converter for driving an electrical machine.

The reference symbols used in the drawings and their meanings are listed in the summary form in the list of reference symbols. In principle, identical parts are provided with the same reference symbols in the figures.

### DETAILED DESCRIPTION

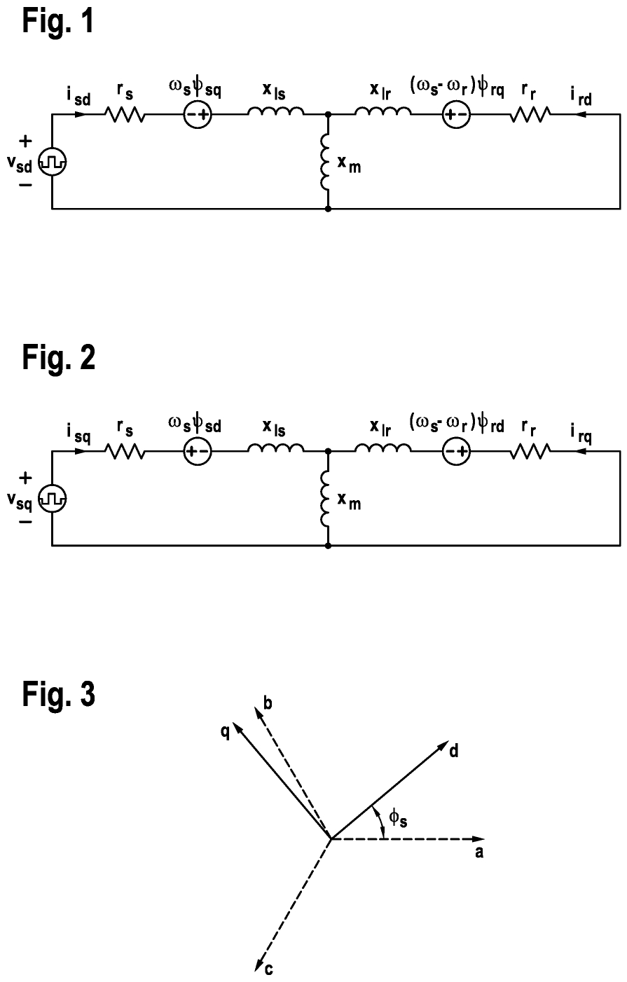

FIG. 1 shows a circuit representation of an induction machine model in a rotating dq-reference frame for a d-axis.

FIG. 2 shows a circuit representation of an induction machine model in the rotating dq-reference frame of FIG. 1 for a q-axis.

FIG. 3 illustrates a definition of the rotating dq-reference frame of FIGS. 1 and 2.

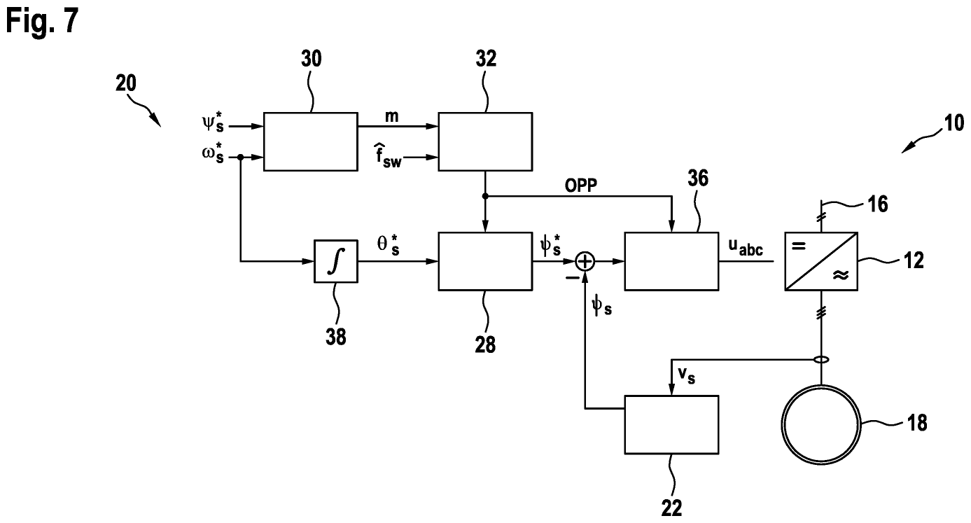

The dq-reference frame rotates with the angular stator frequency ωₛ, with its d-axis position denoted by φₛ. An electrical angular rotor speed is ωᵣ=pωₘ, where p is a number of pole pairs of an electrical machine 18 (see FIG. 7) and ωₘ is a mechanical angular speed of the rotor and shaft of the electrical machine 18. By principle of operation, ωᵣ≠ωₛ due to a slip of the electrical machine 18. A stator voltage vₛ is given by vₛ=[v_{sd}, v_{sq}]^{T}, a stator (rotor) current iₛ (iᵣ) is given by iₛ=[i_{sd}, i_{sq}]^{T} (iᵣ=[i_{rd}, i_{rq}]^{T}), and a stator (rotor) flux vector ψₛ (ψᵣ) is given by ψₛ=[ψ_{sd}, ψ_{sq}]^{T} (ψᵣ=[ψ_{rd}, ψ_{rq}]^{T}). The stator (rotor) flux vector ψₛ (ψᵣ) may be referred to as stator (rotor) flux linkage vector. A stator (rotor) winding resistance Rₛ (Rᵣ) is denoted by Rₛ=diag(rₛ, rₛ) (Rᵣ=diag(rᵣ,rᵣ)), a magnetizing reactance Xₘ is denoted by Xₘ=diag(xₘ,xₘ) and a stator (rotor) leakage reactance Xₗₛ (Xₗᵣ) is denoted by Xₗₛ=diag(xₗₛ,xₗₛ) (Xₗᵣ=diag(xₗᵣ,xₗᵣ)). All quantities, including time t, are normalized in a per unit (p.u.) system.

Using Kirchoff's voltage law, the stator (rotor) voltage vₛ (vᵣ) is given by

$$\begin{matrix}{v}_{s} = {R}_{s} {i}_{s} + \frac{d {ψ}_{s}}{dt} + {ω}_{s} [ \begin{matrix}0 & - 1 \\ 1 & 0\end{matrix} ] {ψ}_{s} , \\ {v}_{r} = {R}_{r} {i}_{r} + \frac{d {ψ}_{r}}{dt} + ( {ω}_{s} - {ω}_{r} ) [ \begin{matrix}0 & - 1 \\ 1 & 0\end{matrix} ] {ψ}_{r} .\end{matrix} \qquad ( 1 )$$

Here, the inverter voltage applied to the stator is given by

$${v}_{s} = [ \begin{matrix}{v}_{sd} \\ {v}_{sq}\end{matrix} ] = P ( {ϕ}_{s} ) {v}_{abc} \qquad ( 2 )$$

$$where$$

$$P ( {ϕ}_{s} ) = \frac{2}{3} [ \begin{matrix}cos ( {ϕ}_{s} ) & cos ( {ϕ}_{s} - \frac{2 π}{3} ) & cos ( {ϕ}_{s} + \frac{2 π}{3} ) \\ - sin ( {ϕ}_{s} ) & - sin ( {ϕ}_{s} - \frac{2 π}{3} ) & - sin ( {ϕ}_{s} + \frac{2 π}{3} )\end{matrix} ] \qquad ( 3 )$$

is the matrix used to transform quantities from an abc-reference frame into the dq-reference frame. The stator and rotor flux vectors ψₛ, ψᵣ are given by

$$\begin{matrix}{ψ}_{s} = {X}_{s} {i}_{s} + {X}_{m} {i}_{r} \\ {ψ}_{r} = {X}_{r} {i}_{r} + {X}_{m} {i}_{s}\end{matrix} \qquad ( 4 )$$

where Xₛ=Xₗₛ+Xₘ and Xᵣ=Xₗᵣ+Xₘ are the stator and, respectively, rotor linkage reactances Xₛ, Xᵣ. An electromagnetic torque Tₑ of the electrical machine 18 is given by

$${T}_{e} = \frac{1}{p f} {ψ}_{s} \times {i}_{s} \qquad ( 5 )$$

where pf is a power factor. Using formula (4), formula (5) may be written as

$$\begin{matrix}{T}_{e} = \frac{1}{p f} \frac{{x}_{m}}{{x}_{s} {x}_{r} - {x}_{m}^{2}} {ψ}_{r} \times {ψ}_{s} \\ = \frac{1}{p f} \frac{{x}_{m}}{{x}_{s} {x}_{r} - {x}_{m}^{2}} ‖ {ψ}_{s} ‖ ‖ {ψ}_{r} ‖ sin ( γ )\end{matrix} \qquad ( 6 )$$

where γ is an angle between stator and rotor flux linkage vectors ψₛ, ψᵣ.

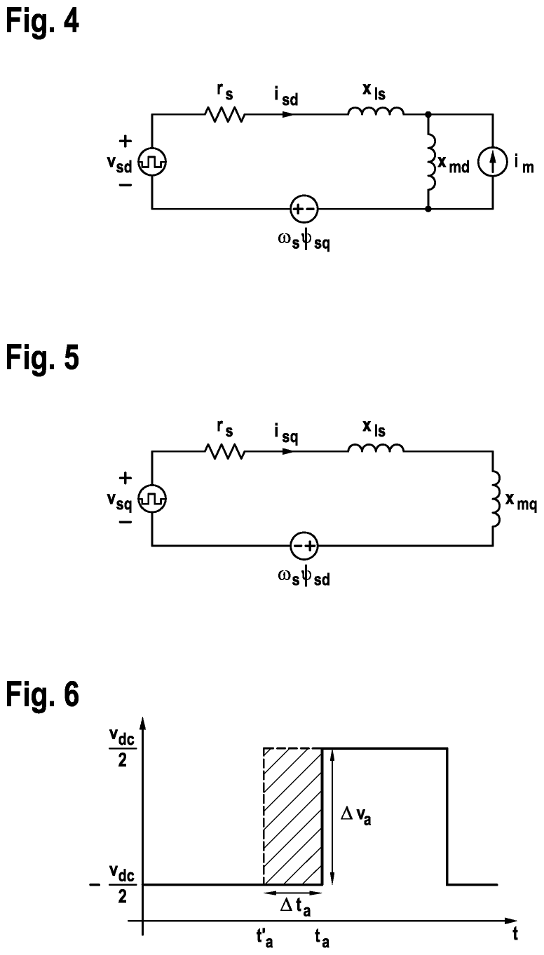

FIG. 4 shows a circuit representation of a permanent-magnet synchronous machine in the rotating dq-reference frame of FIG. 3 for a d-axis.

FIG. 5 shows a circuit representation of a permanent-magnet synchronous machine (PMSM) in the rotating dq-reference frame of FIG. 3 for a q-axis.

The dq-reference frame rotates with the angular stator speed ωₛ. By principle of operation, ωₛ=ωᵣ. It may be assumed that the d-axis is aligned with the orientation of the permanent magnet mounted on the rotor of the PMSM. Hence, the rotor flux vector ψᵣ is given by

$${ψ}_{r} = [ \begin{matrix}{ψ}_{r d} \\ {ψ}_{rq}\end{matrix} ] = [ \begin{matrix}{x}_{md} {i}_{m} \\ 0\end{matrix} ] = [ \begin{matrix}{Ψ}_{PM} \\ 0\end{matrix} ] \qquad ( 7 )$$

where iₘ is a hypothetical constant magnetization current flowing through the magnetizing inductance x_{md}. A constant magnetic flux linkage is denoted by Ψ_{PM} and is generated by a permanent magnet of the electrical machine 18. The stator flux vector ψₛ is given by

$${ψ}_{s} = {X}_{s} {i}_{s} + {ψ}_{r} . \qquad ( 8 )$$

Applying Kirchoff's voltage law, the dynamics of the stator voltage vₛ are given by

$${v}_{s} = {R}_{s} {i}_{s} + \frac{d {ψ}_{s}}{dt} + {ω}_{s} [ \begin{matrix}0 & - 1 \\ 1 & 0\end{matrix} ] {ψ}_{s} . \qquad ( 9 )$$

The electromagnetic torque Tₑ is given by

$$\begin{matrix}{T}_{e} = \frac{1}{p f} {ψ}_{s} \times {i}_{s} \\ = \frac{1}{p f} {ψ}_{s} \times {X}_{s}^{- 1} ( {ψ}_{s} - {ψ}_{r} ) \\ = \frac{1}{p f} \frac{1}{{x}_{sd}} ( \frac{{x}_{sd} - {x}_{sq}}{{x}_{sq}} {ψ}_{sd} + {ψ}_{r d} ) {ψ}_{sq}\end{matrix} \qquad ( 10 )$$

Note that due to the saliency of the electrical machine 18, the electromagnetic torque Tₑ is also a function of the d-component of the stator flux. Recalling that the d-axis of the rotating dq-reference frame is aligned with the rotor flux vector ψᵣ, the stator flux vector ψₛ may be expressed by ψₛ=[∥ψₛ∥cos(γ), ∥ψₛ∥sin(γ)]^{T}.

Then, formula (10) may be written as

$${T}_{e} = \frac{1}{p f} \frac{1}{{x}_{sd}} ( \frac{1}{2} \frac{{x}_{sd} - {x}_{sq}}{{x}_{sq}} {‖ {ψ}_{s} ‖}^{2} sin ( 2 γ ) + {Ψ}_{PM} ‖ {ψ}_{s} ‖ sin ( γ ) ) \qquad ( 11 )$$

where γ is the angle between stator and rotor flux vectors ψₛ, ψᵣ.

Optimized pulse patterns (OPPs) relate to a specific pulse width modulation (PWM) method which enables minimization of the harmonic current distortions for a given switching frequency and are well known in the art. Compaed with carrier-based PWM, the use of OPPs results in a lower switching frequency of semiconductor devices of an electrical converter for a given current total harmonic distortion (THD), in a lower current THD for a given switching frequency which implies lower machine losses of the electrical machine, and in lower machine inductances or smaller LC filters during the system design phase as an effect of the ability of OPPs to shape the current harmonic spectrum.

Hence, it can be inferred that the use of OPPs lifts the artificial and unnecessary constraint of a fixed modulation interval imposed in carrier-based PWM when optimizing the system during design and operation.

To enable the use of OPPs in electrical drive systems, the concept of model predictive pulse pattern control (MP³C) has been described in EP 2 469 692 A1. MP³C controls the position of the stator flux vector ψₛ of the electrical machine 18 along an optimal flux trajectory, which is the integral of the OPP voltage waveform over time. It achieves this by manipulating in real time the switching instants of the offline computed OPP, as described in EP 2 891 241 B1.

A control objective of a drive system may be to achieve a regulation of the electrical angular rotor speed ψᵣ to the desired reference value ψᵣ*. This may be achieved by appropriately adjusting the angle between stator and rotor flux vector ψₛ, ψᵣ which may be computed by solving a nonlinear trigonometric equation (c.f., (6) and (11)) that depends on the type of the electrical machine 18, machine parameters, and/or the rotor flux vector ψᵣ, e.g. on its orientation and/or magnitude. The electrical machine 18 may for example be an induction machine or permanent magnet machine. The machine parameters may for example be magnetizing and leakage inductances. However, acquiring knowledge of these quantities is a hard task in several applications, while robustness of the system is hindered by a false estimation of them.

FIG. 6 shows an example of a switching pattern modification by a MP³C as described in the above-mentioned prior art. An inner feedback loop of MP³C is responsible for driving the stator flux vector ψₛ towards the reference stator flux vector ψₛ*. This task may be achieved by a pattern controller module 36 (see FIG. 7), which may modify switching instants of the OPP to compensate for the difference between the stator flux vector ψₛ and the reference stator flux vector ψₛ*. A resulting pulse pattern may be encoded in a switching signal u_{abc} (see FIG. 7) and may be used for driving the semiconductor switches of the electrical converter 12 (see FIG. 7). To illustrate this control principle, a two-level converter with stator flux vector ψₛ in phase a may be given by

$${ψ}_{sa} ( t ) = {ψ}_{sa} ( 0 ) + {{{\int }^{t}}_{0}}^{t} {v}_{a} ( τ ) d τ \begin{matrix}l τ \\ \end{matrix} , \qquad ( 12 )$$

where vₐ(t)∈{−V_{dc}/2, V_{dc}/2}, with V_{dc} denoting the voltage of a dc-link 16 (see FIG. 7).

Here, it is implicitly assumed that the stator resistance is negligible. It is noted that formula (12) may be used by an observer module 22 to compute the actual stator flux vector ψₛ. Let vₐ(0)∈{−V_{dc}/2, V_{dc}/2} be the voltage output at t=0 and assume that a switching transition Δvₐ={−V_{dc},V_{dc}} may occur at time tₐ∈(0,t). So, the reference stator flux vector ψₛ* may be given by

$$\begin{matrix}{ψ}_{sa}^{s} ( t ) = {ψ}_{sa} ( 0 ) + {{\int }^{{t}_{a}}}_{0} {v}_{a} ( 0 ) d τ + {{\int }^{t}}_{{t}_{a}} ( {v}_{a} ( 0 ) + Δ {v}_{a} ) d τ \\ = {ψ}_{sa} ( 0 ) + {v}_{a} ( 0 ) {t}_{a} + ( {v}_{a} ( 0 ) + Δ {v}_{a} ) ( t - {t}_{a} ) .\end{matrix} \qquad ( 13 )$$

If this switching instant is delayed or forwarded by a time interval Δtₐ, i.e. the switching instant occurs at time tₐ+Δtₐ, this results in

$$\begin{matrix}{ψ}_{sa} ( t ) = {ψ}_{sa} ( 0 ) + {{\int }^{{t}_{a} + Δ {t}_{a}}}_{0} {v}_{a} ( 0 ) d τ + {{\int }^{t}}_{{t}_{a} + Δ {t}_{a}} ( {v}_{a} ( 0 ) + Δ {v}_{a} ) d τ \\ = {ψ}_{sa} ( 0 ) + {v}_{a} ( 0 ) ( {t}_{a} + Δ {t}_{a} ) + ( {v}_{a} ( 0 ) + Δ {v}_{a} ) ( t - {t}_{a} - Δ {t}_{a} ) \\ = {ψ}_{sa}^{*} ( t ) + Δ {v}_{a} Δ {t}_{a} .\end{matrix} \qquad ( 14 )$$

This implies that

$$Δ {ψ}_{sa} ( t ) = Δ {v}_{a} Δ {t}_{a} . \qquad ( 15 )$$

Hence, based on the difference between the measured stator flux vector ψₛ and the reference stator flux vector ψₛ* the pattern controller 36 may decide whether there is a need to delay or advance the OPP switching instants. Although this section illustrates the basic principle of operation of the pattern controller, the actual implementation may be more complicated, including functionalities such as pulse insertion which may allow for fast control of the stator flux during transients and to achieve disturbance rejection.

FIG. 7 shows an electrical system 10 comprising an electrical converter 12, a DC link 16, an electrical machine 18, and a controller 20. The electrical converter 12 comprises several semiconductor switches (not shown) and interconnects the DC link 16 with the electrical machine 18. The electrical converter 12 may be controlled by the controller 20. The electrical converter 12 may be an inverter. It may be a voltage source or a current source converter 12. In particular, the converter 12 may be a high-power converter adapted for converting current with more than 100 A and/or 1000 V. The electrical machine 18 may be an electric motor or a generator, or it may be operated as an electric motor in a first operation mode and as a generator in a second operation mode.

As explained in the following, the controller 20 embodies a Model-Free Scalar Pulse Pattern Control (MF-SPPC) scheme. The MF-SPPC scheme may be a closed-loop control scheme responsible for regulating a magnitude of a stator flux to its reference value, in particular the reference stator flux magnitude ψₛ*, during transient events and in the presence of disturbances in a dc-link voltage of the DC link 16. This task may be achieved for a given and/or predetermined reference angular stator frequency ψₛ* (or speed). By adjusting the reference angular stator frequency ωₛ*, a steady state value of an angular rotor speed may also be adjusted. The MF-SPPC scheme may be seen as a bare bone control scheme based on OPPs which does not rely on any knowledge of the machine type and its parameters to achieve its control objectives. In particular, unlike its MP³C counterpart, MF-SPPC does not rely on any information regarding the machine type and its parameters.

The controller 20 comprises an observer module 22 that may receive an output voltage vs of the electrical converter 12. The output voltage vₛ may be an input for the electrical motor 18 and/or may be measured at corresponding outputs of the electrical converter 12. The observer module 22 may also receive a DC-link voltage of the DC-link 16 and/or a switching signal u_{abc}, in which three-phase switch positions are encoded, to reconstruct the output voltage vₛ applied to input terminals of the electrical machine 18, instead of receiving the measured output voltage vₛ. Based on the measured output voltage vₛ, the observer module 22 may estimate a stator flux vector ψₛ of the electrical machine 18.

An integration module 38 of the controller 20 may comprise an integrator. The integration module 38 may determine the reference stator angle θₛ* by integrating the reference angular stator frequency ωₛ* with respect to time.

A flux reference module 28 of the controller 20 may determine a reference stator flux vector ψₛ*, which lies on an optimal flux trajectory, and may have a desired angle and a desired magnitude. In particular, the optimal flux trajectory may be obtained by integrating a pre-calculated optimized pulse pattern OPP that is selected by a pattern loader module 32 of the controller 20 based on a modulation index m provided by a modulation index module 30 of the controller 20 and a maximum allowed switching frequency \hat{f}_{sw} of the electrical converter 12. The maximum allowed switching frequency \hat{f}_{sw} of the electrical converter 12 may be determined in advance and may be stored on a memory (not shown) of the controller 20.

The modulation index module 30 may provide at its output the desired modulation index m. The modulation index module 30 may determine the modulation index m depending on the reference angular stator frequency ωₛ*.

The pattern controller module 36 may be a conventional pattern controller module 36, e.g. as described in the above-mentioned prior art. The pattern controller module 36 may provide one, two or more functionalities as described above with respect to FIG. 6. The pattern controller module 36 may generate the vector of switch positions encoded in the switching signal u_{abc} that may be applied to the converter 12.

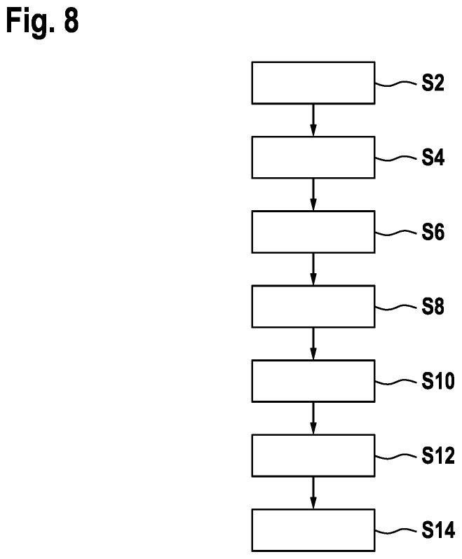

FIG. 8 shows a flow diagram of an exemplary embodiment of a method for controlling the electrical converter 12 for driving the electrical machine 18. The method may be carried out by the controller 20.

In the following, normalized quantities are used and it is focused on a three-phase inverter 12 connected to an electrical machine 18. However, it has to be understood that the following embodiments also may be applied to an inverter connected to a general p-phase load or to a grid-connected converter connected to a power grid, in which the converter may be grid forming by setting the amplitude and frequency of the grid voltage. Additional passive elements, such as filters, transformers and/or cables may be added.

In a step S2, the stator flux vector ψₛ may be estimated depending on at least one measurement in the electrical converter 12, e.g. by the observer 22. The at least one measurement in the electrical converter 12 may comprise measuring the stator voltage vₛ of the electrical converter 12. Then, the stator flux vector ψₛ may be estimated depending on the stator voltage vₛ, e.g. by the above formulas (1) or (9).

In a step S4, the optimized pulse pattern OPP for the electrical converter 12 may be determined, e.g. as described in EP 2 469 692 A1. For example, the optimized pulse pattern OPP may be determined depending on the modulation index m and/or the maximum allowed switching frequency \hat{f}_{sw}, e.g. by the pattern loader module 32, wherein the modulation index m may be determined depending on a reference stator flux magnitude ψₛ* and/or depending on the reference angular stator frequency ωₛ*. In particular, the optimized pulse pattern OPP may be determined depending on the reference stator flux magnitude ψₛ*, wherein the fundamental component stator flux vector ψₛ may determine the modulation index m of the optimized pulse pattern OPP.

The optimized pulse pattern OPP may comprise a sequence of switching transitions at switching instants between different switching states of the converter 12. The determined optimized pulse pattern OPP may be loaded from a table of optimized pulse patterns. The table of optimized pulse patterns may be stored in a memory of the controller 20. The table of optimized pulse patterns may be indexed with respect to the modulation index m, and optionally with respect to the maximum allowed switching frequency \hat{f}_{sw}. For each optimized pulse pattern OPP in the table, switching transitions at switching instants may be stored.

In a step S6, the reference stator angle θₛ* of the stator flux vector ψₛ may be determined depending on the reference angular stator frequency ωₛ*, e.g. by the integration module 38.

In a step S8, the reference flux vector ψₛ* may be determined depending on the optimized pulse pattern OPP and the reference stator angle θₛ*, e.g. by the flux reference module 28.

In a step S10, the difference between the reference stator flux vector ψₛ* and the estimated stator flux vector ψₛ, i.e. the stator flux error, may be determined, e.g. by the controller 20.

In a step S12, the switching instants of the optimized pulse pattern OPP may be modified, e.g. by the pattern controller module 36, e.g. such that the stator flux error is minimized, e.g. as explained above and/or described in EP 2 891 241 B1.

In a step S14, at least a part of the modified optimized pulse pattern OPP, e.g. by the switching signal u_{abc}, may be applied to the electrical converter 12, e.g. by the pattern controller module 36.

The functional modules may be implemented as programmed software modules or procedures, respectively; however, someone skilled in the art will understand that the functional modules may be implemented fully or partially in hardware.

While the disclosure has been illustrated and described in detail in the drawings and foregoing description, such illustration and description are to be considered illustrative or exemplary and not restrictive; the disclosure is not limited to the disclosed embodiments. Other variations to the disclosed embodiments can be understood and effected by those skilled in the art and practising the claimed disclosure, from a study of the drawings, the disclosure, and the appended claims. In the claims, the word “comprising” does not exclude other elements or steps, and the indefinite article “a” or “an” does not exclude a plurality. A single processor or controller or other unit may fulfil the functions of several items recited in the claims. The mere fact that certain measures are recited in mutually different dependent claims does not indicate that a combination of these measures cannot be used to advantage. Any reference signs in the claims should not be construed as limiting the scope.

1. A method for controlling an electrical converter configured to drive an electrical machine, the method comprising:
estimating a stator flux vector based on at least one measurement in the electrical converter;
determining an optimized pulse pattern for the electrical converter based on a reference angular stator frequency;
determining a reference stator angle of the stator flux vector based on the reference angular stator frequency;
determining a reference stator flux vector based on the optimized pulse pattern and the reference stator angle;
determining a difference between the reference stator flux vector and the estimated stator flux vector;
modifying switching instants of the optimized pulse pattern, such that the difference is minimized; and
applying at least a part of the modified optimized pulse pattern to the electrical converter.

2. The method of claim 1, wherein:
the reference stator angle is determined by integrating the reference angular stator frequency.

3. The method of claim 1, wherein;
the optimized pulse pattern is determined based on a reference stator flux magnitude.

4. The method of claim 3, wherein:
the optimized pulse pattern is determined based on a modulation index and/or a maximum allowed switching frequency, and
the modulation index is determined based on the reference angular stator frequency and/or the reference stator flux magnitude.

5. The method of claim 1, wherein:
the at least one measurement in the electrical converter comprises measuring a stator voltage of the electrical converter, and
the stator flux vector is estimated based on the stator voltage.

6. The method of claim 1, wherein:
the optimized pulse pattern comprises a sequence of switching transitions at switching instants between different switching states of the converter,
the optimized pulse pattern is loaded from a table of optimized pulse patterns stored in a controller performing the method,
the table of optimized pulse patterns is indexed with respect to the modulation index, and
for each optimized pulse pattern in the table, switching transitions at switching instants are stored.

7. A computer program, which when being executed on a processor, causes the processor to perform the steps of the method of claim 1.

8. A non-transitory computer-readable medium in which the computer program according to claim 7 is stored.

9. A controller configured to control the electrical converter and configured to perform the steps of the method of claim 1.

10. An electrical converter, comprising:
a plurality of semiconductor switches; and
the controller according to claim 9 configured to control the plurality of semiconductor switches of the electrical converter.

11. An electrical machine, comprising:
an electrical converter configured to drive the electrical machine; and
a controller configured to:
estimate a stator flux vector based on at least one measurement in the electrical converter;
determine an optimized pulse pattern for the electrical converter based on a reference angular stator frequency;
determine a reference stator angle of the stator flux vector based on the reference angular stator frequency;
determine a reference stator flux vector based on the optimized pulse pattern and the reference stator angle;
determine a difference between the reference stator flux vector and the estimated stator flux vector;
modify switching instants of the optimized pulse pattern, such that the difference is minimized; and
apply at least a part of the modified optimized pulse pattern to the electrical converter.

12. The electrical machine of claim 11, wherein:
the controller is further configured to determine the reference stator angle by integrating the reference angular stator frequency.

13. The electrical machine of claim 11, wherein:
the controller is further configured to determine the optimized pulse pattern based on a reference stator flux magnitude.

14. The electrical machine of claim 13, wherein:
the controller is further configured to:
determine the optimized pulse pattern based on a modulation index and/or a maximum allowed switching frequency, and
determine the modulation index based on the reference angular stator frequency and/or the reference stator flux magnitude.

15. The electrical machine of claim 11, wherein:
the controller is further configured, to perform the at least one measurement in the electrical converter, to:
measure a stator voltage of the electrical converter; and
estimate the stator flux vector based on the stator voltage.

16. The electrical machine of claim 11, wherein:
the optimized pulse pattern comprises a sequence of switching transitions at switching instants between different switching states of the converter,
the controller is further configured to load the optimized pulse pattern from a table of optimized pulse patterns stored in the controller,
the table of optimized pulse patterns is indexed with respect to the modulation index, and
for each optimized pulse pattern in the table, switching transitions at switching instants are stored.
